(19) United States
(12) Patent Application Publication
(10) Pub. No.: US 2005/0060545 A1
(43) Pub. Date: Mar. 17, 2005

(54) Secure provision of image data

(75) Inventors: Marco Casassa Mont, Bristol (GB); Keith Alexander Harrison, Monmouthshire (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/941,262

(22) Filed: Sep. 14, 2004

(30) Foreign Application Priority Data
Sep. 17, 2003 (GB) 0321807.0

(51) Int. Cl. H04L 9/00

(52) U.S. Cl. 713/165

(57) ABSTRACT

A method and apparatus are provided for the secure provision of payload data that comprises image data representing an image. The payload data is encrypted using encryption parameters comprising public data of a trusted party and an encryption key string. The encryption key string comprises thumbnail data that represents a low-resolution version of the image represented by the image data. The encryption key string preferably also comprises at least one condition to be met before the trusted party releases a decryption key for decrypting the encrypted payload data; advantageously, the apparatus enables a user to select, via a user interface, one or more conditions for incorporation into the encryption key string. The functionality for generating the thumbnail data, for choosing the conditions to be used for the encryption key string, and for encrypting the payload data is preferably incorporated into a physical add-in module such as a PCMCIA card.

### FIELD OF THE INVENTION

The present invention relates to a method and apparatus for the secure provision of image data and to a physical add-in module for use in such apparatus.

### BACKGROUND OF THE INVENTION

Mobile multimedia appliances such as Internet-based cameras, multimedia mobile phones and wireless PDAs, allow users to generate multimedia information (image, video, sound, etc.) and transmit it, on-the-fly, to third parties in a highly dynamic way without requiring the access to mediation devices. This allows consumers to simplify and speed up their social interactions and professional people (such as reporters, etc.) to capture images and immediately send them back to information centres.

In traditional information technology systems (such as e-mail browsers, web browsers, etc.) protecting the privacy and confidentiality of digital data is usually effected by employing cryptographic mechanisms. Typical solutions use encryption techniques based on symmetric keys and/or RSA technology. Whilst these solutions are acceptable in traditional systems they are not straightforward to configure, use and manage in mobile appliances.

As a result, current mobile appliances mainly generate and transmit this information in clear or by means of point-to-point secured transmission channels. This information is usually stored by Telecom carriers, ISP providers or service providers either in clear or after these entities encrypt it. With the increasing diversity of inter-appliance communication options, relying on an infrastructure provider to carry out data encryption is likely to be unrealistic and to give rise to inflexible architectures.

Another approach used to secure data generated by mobile appliances is to rely on encryption functionality provided by a proxy device such as a docking station, PC, etc. Proxies usually leverage traditional encryption technologies and PKI solutions (including S/MIME, SSL and identity certificates) to provide privacy and security. Information can be encrypted by using the receiver's public certificate or shared secrets. However, such an approach not only suffers from inflexibility but uses encryption technology that is hard to configure, use and manage.

It is an object of the present invention to facilitate the protection of data, and in particular image data, provided by apparatus such as a mobile appliance.

Embodiments of the present invention to be described hereinafter make use of a cryptographic technology known as identifier-based encryption. Accordingly, a brief description will now be given of this type of encryption.

Identifier-Based Encryption (IBE) is an emerging cryptographic schema. In this schema (see FIG. 1 of the accompanying drawings), a data provider 10 encrypts payload data 13 using both an encryption key string 14, and public data 15 provided by a trusted authority 12. This public data 15 is related to private data held by the trusted authority; for example, the public data is derived by the trusted authority 12 from private data 17 using a one-way function 18. The data provider 10 then provides the encrypted payload data <13> to a recipient 11 who decrypts it, or has it decrypted, using a decryption key computed by the trusted authority 12 in dependence on the encryption key string and its own private data.

A feature of identifier-based encryption is that because the decryption key is generated from the encryption key string, its generation can be postponed until needed for decryption.

Another feature of identifier-based encryption is that the encryption key string is cryptographically unconstrained and can be any kind of string, that is, any ordered series of bits whether derived from a character string, a serialized image bit map, a digitized sound signal, or any other data source. The string may be made up of more than one component and may be formed by data already subject to upstream processing. In order to avoid cryptographic attacks based on judicious selection of a key string to reveal information about the encryption process, as part of the encryption process the encryption key string is passed through a one-way function (typically some sort of hash function) thereby making it impossible to choose a cryptographically-prejudicial encryption key string. In applications where defence against such attacks is not important, it would be possible to omit this processing of the string.

Frequently, the encryption key string serves to “identify” the intended message recipient and the trusted authority is arranged to provide the decryption key only to this identified intended recipient. This has given rise to the use of the label “identifier-based” or “identity-based” generally for cryptographic methods of the type under discussion. However, depending on the application to which such a cryptographic method is put, the string may serve a different purpose to that of identifying the intended recipient and may be used to convey other information to the trusted authority or, indeed, may be an arbitrary string having no other purpose than to form the basis of the cryptographic processes. Accordingly, the use of the term “identifier-based” or “IBE” herein in relation to cryptographic methods and systems is to be understood simply as implying that the methods and systems are based on the use of a cryptographically unconstrained string whether or not the string serves to identify the intended recipient. Generally, in the present specification, the term “encryption key string” or “EKS” is used rather than “identity string” or “identifier string”; the term “encryption key string” is also used in the shortened form “encryption key” for reasons of brevity.

A number of IBE algorithms are known and FIG. 2 indicates, for three such algorithms, the following features, namely:
the form of the encryption parameters 5 used, that is, the encryption key string and the public data of the trusted authority (TA);
the conversion process 6 applied to the encryption key string to prevent attacks based on judicious selection of this string;
the primary encryption computation 7 effected;
the form of the encrypted output 8.

The three prior art IBE algorithms to which FIG. 2 relates are:
Quadratic Residuosity (QR) method as described in the paper: C. Cocks, “An identity based encryption scheme based on quadratic residues”, Proceedings of the 8^{th} IMA International Conference on Cryptography and Coding, LNCS 2260, pp 360-363, Springer-Verlag, 2001. A brief description of this form of IBE is given hereinafter.
Bilinear Mappings ρ using, for example, a modified Tate pairing or modified Weil pairing for which:
   ρ: G₁×G₁→G₂
   where G₁ and G₂ denote two algebraic groups of large prime order l in which the discrete logarithm problem is believed to be hard. G₁ is a [l]-torsion subgroup of a larger algebraic group G₀ and satisfies [l]P=O for all P ε G₁ where O is the infinite element, l is a large prime, and l*cofactor=number of elements in G₀. G₂ is a subgroup of a multiplicative group of a finite field. For the Tate pairing, an asymmetric mapping is also possible:
   ρ: G₁×G₀→G₂
   Generally, the elements of the groups G₀ and G₁ are points on an elliptic curve (typically, though not necessarily, a supersingular curve); however, this is not necessarily the case. A description of this form of IBE method, using modified Weil pairings is given in the paper: D. Boneh, M. Franklin—“Identity-based Encryption from the Weil Pairing” in Advances in Cryptology—CRYPTO 2001, LNCS 2139, pp. 213-229, Springer-Verlag, 2001.
RSA-Based methods The RSA public key cryptographic method is well known and in its basic form is a two-party method in which a first party generates a public/private key pair and a second party uses the first party's public key to encrypt messages for sending to the first party, the latter then using its private key to decrypt the messages. A variant of the basic RSA method, known as “mediated RSA”, requires the involvement of a security mediator in order for a message recipient to be able to decrypt an encrypted message, this being achieved by dividing the decryption key between the recipient and security mediator. An IBE method based on mediated RSA is described in the paper “Identity based encryption using mediated RSA”, D. Boneh, X. Ding and G. Tsudik, 3rd Workshop on Information Security Application, Jeju Island, Korea, August, 2002. An RSA-based IB method that does not require dividing the decryption key is described in U.S. Pat. No. 6,275,936; here, the decryption key is dynamically computed from the encryption key, the latter being a hash of the sender-chosen string.

A more detailed description of the QR method is given below with reference to the entities depicted in FIG. 1 and using the same notation as given for this method in FIG. 2. In the QR method, the trust authority's public data 15 comprises a value N that is a product of two random prime numbers p and q, where the values of p and q are the private data 17 of the trust authority 12. The values of p and q should ideally be in the range of 2⁵¹¹ and 2⁵¹² and should both satisfy the equation: p,q≡3 mod 4. However, p and q must not have the same value. Also provided is a hash function # which when applied to a string returns a value in the range 0 to N−1.

Each bit of the user's payload data 13 is then encrypted as follows:
The data provider 10 generates random numbers t₊ (where t₊ is an integer in the range [0, 2^{N}]) until a value of t₊ is found that satisfies the equation jacobi(t₊,N)=m′, where m′ has a value of −1 or 1 depending on whether the corresponding bit of the user's data is 0 or 1 respectively. (As is well known, the jacobi function is such that where x²≡#modN the jacobi (#, N)=−1 if x does not exist, and =1 if x does exist). The data provider 10 then computes the value:
   s₊≡(t₊+K/t₊)modN
   where: s₊ corresponds to the encrypted value of the bit m′ concerned, and
   K=#(encryption key string)
Since K may be non-square, the data provider additionally generates additional random numbers t_ (integers in the range [0, 2^{N})) until one is found that satisfies the equation jacobi(t_, N)=m′. The data provider 10 then computes the value:
   s_≡(t_{—}−K/t_)modN
   as the encrypted value of the bit m concerned.

The encrypted values s₊ and s₋ for each bit m′ of the user's data are then made available to the intended recipient 11, for example via e-mail or by being placed in a electronic public area; the identity of the trust authority 12 and the encryption key string 14 will generally also be made available in the same way.

The encryption key string 14 is passed to the trust authority 12 by any suitable means; for example, the recipient 11 may pass it to the trust authority or some other route is used—indeed, the trust authority may have initially provided the encryption key string. The trust authority 12 determines the associated private key B by solving the equation:
B²≡K modN (“positive” solution)

If a value of B does not exist, then there is a value of B that is satisfied by the equation:
B²≡−K modN (“negative” solution)

As N is a product of two prime numbers p, q it would be extremely difficult for any one to calculate the decryption key B with only knowledge of the encryption key string and N. However, as the trust authority 12 has knowledge of p and q (i.e. two prime numbers) it is relatively straightforward for the trust authority 12 to calculate B.

Any change to the encryption key string 14 will result in a decryption key 16 that will not decrypt the payload data 13 correctly. Therefore, the intended recipient 11 cannot alter the encryption key string before supplying it to the trust authority 12.

The trust authority 12 sends the decryption key to the data recipient 11 along with an indication of whether this is the “positive” or “negative” solution for B.

If the “positive” solution for the decryption key has been provided, the recipient 11 can now recover each bit m′ of the payload data 13 using:
m′=jacobi(s₊+2B,N)

If the “negative” solution for the decryption key B has been provided, the recipient 11 recovers each bit m′ using:
m′=jacobi(s₋+2B,N)

### SUMMARY OF THE INVENTION

According to one aspect of the present invention, there is provided a method for the secure provision of image data representing an image, the method comprising:
generating thumbnail data that represents a low-resolution version of the image represented by said image data;
encrypting payload data comprising said image data, this encryption being effected using encryption parameters comprising public data of a trusted party and an encryption key string comprising said thumbnail data; and
outputting the encrypted payload data and said encryption key string.

Placing the thumbnail data in the encryption key string tightly binds the unencrypted (and therefore viewable) thumbnail to the full image data.

Preferably, the encryption key string further comprises at least one condition to be satisfied before the trusted party provides a decryption key for decrypting the payload data; the at least one condition thus forms a “policy” for release of the decryption key. This policy is advantageously managed by a user using a policy editor that can conveniently be provided, along with encryption functionality, in a physical add-in module.

According to another aspect of the present invention, there is provided a method for the secure provision of payload data that comprises image data representing an image, the method comprising encrypting the payload data using an Identifier-Based Encryption process employing an encryption key string comprising data that represents a low-resolution version of said image.

According to a further aspect of the present invention, there is provided apparatus for the secure provision of image data representing an image, the apparatus comprising:
a first arrangement arranged to provide payload data comprising said image data;
second arrangement arranged to generate thumbnail data that represents a low-resolution version of the image represented by said image data;
a third arrangement arranged to encrypt the payload data using encryption parameters comprising public data of a trusted party and an encryption key string comprising said thumbnail data; and
a fourth arrangement arranged to output the encrypted payload data and said encryption key string.

According to a yet further aspect of the present invention, there is provided a physical add-in module for enabling apparatus to which the module has been added to securely provide payload data that comprises image data, the module comprising:
first means for generating thumbnail data that represents a low-resolution version of the image represented by said image data;
second means for forming an encryption key string comprising said thumbnail data; and at least one condition selected by a user of the apparatus via a user interface of the latter; and
third means for encrypting the payload data using encryption parameters comprising public data of a trusted party and said encryption key string.

### BRIEF DESCRIPTION OF THE DRAWINGS

Embodiments of the invention will now be described, by way of non-limiting example, with reference to the accompanying diagrammatic drawings, in which:

FIG. 1 is a diagram illustrating the operation of a prior art encryption schema known as Identifier-Based Encryption (IBE);

FIG. 2 is a diagram illustrating how certain IBE operations are implemented by three different prior art IBE methods; and

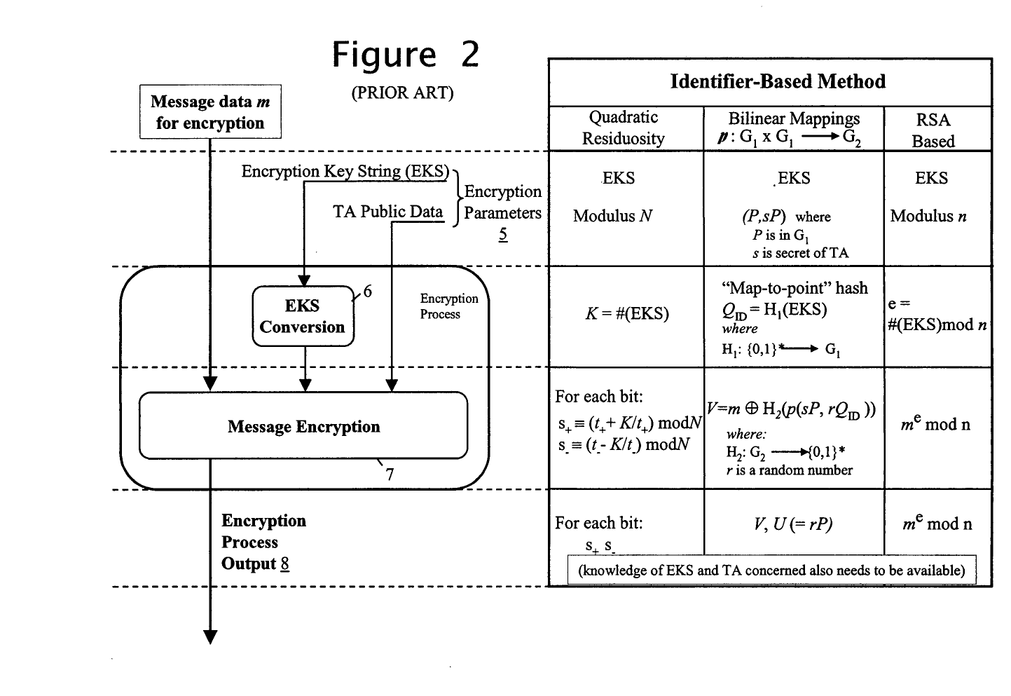

FIG. 3 is a diagram of an embodiment of the present invention.

### BEST MODE OF CARRYING OUT THE INVENTION

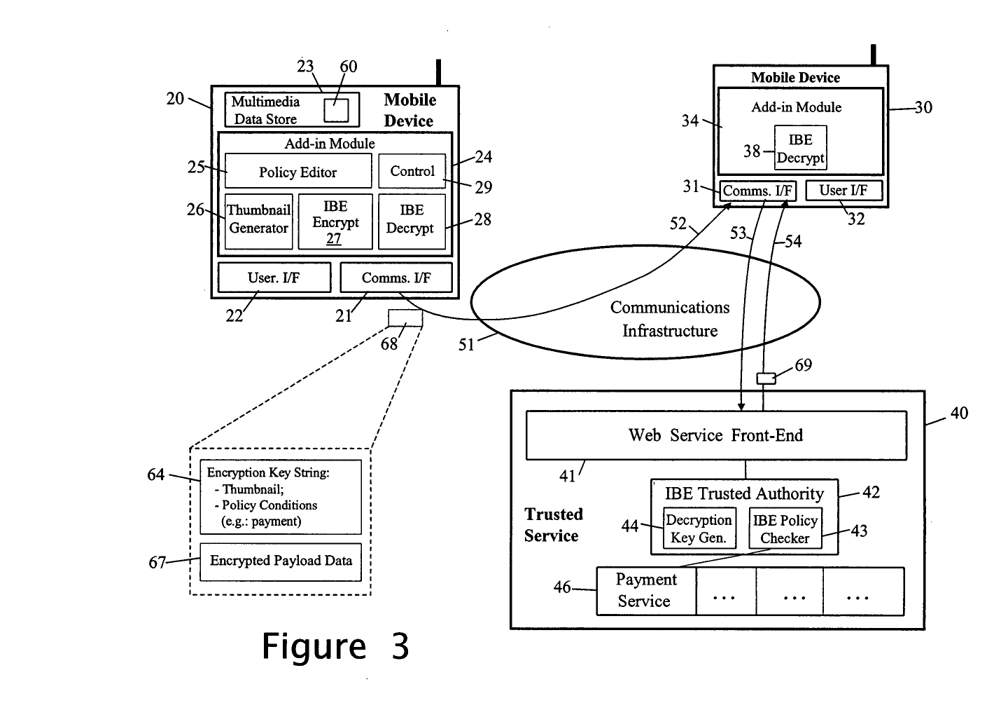

FIG. 3 illustrates an arrangement in which a data-provider mobile device 20 is arranged to encrypt image data 60 and send it to a data-recipient mobile device 30 which then requests a decryption key 69 from a trusted service 40 and, on receipt of the key, decrypts and uses the image data. The entities 20, 30 and 40 inter-communicate, for example, via the internet or other communications infrastructure 51 though it is also possible that communication between at least two of the entities is direct or that the trusted service is integrated with the data-provider mobile device 20.

The data-provider mobile device 20 is, for example, a mobile phone with camera functionality (not shown) for capturing an image as image data (such as image data 60); by way of a further example, the mobile device 20 can be a PDA storing image data 60 provided to it by another apparatus (also not shown).

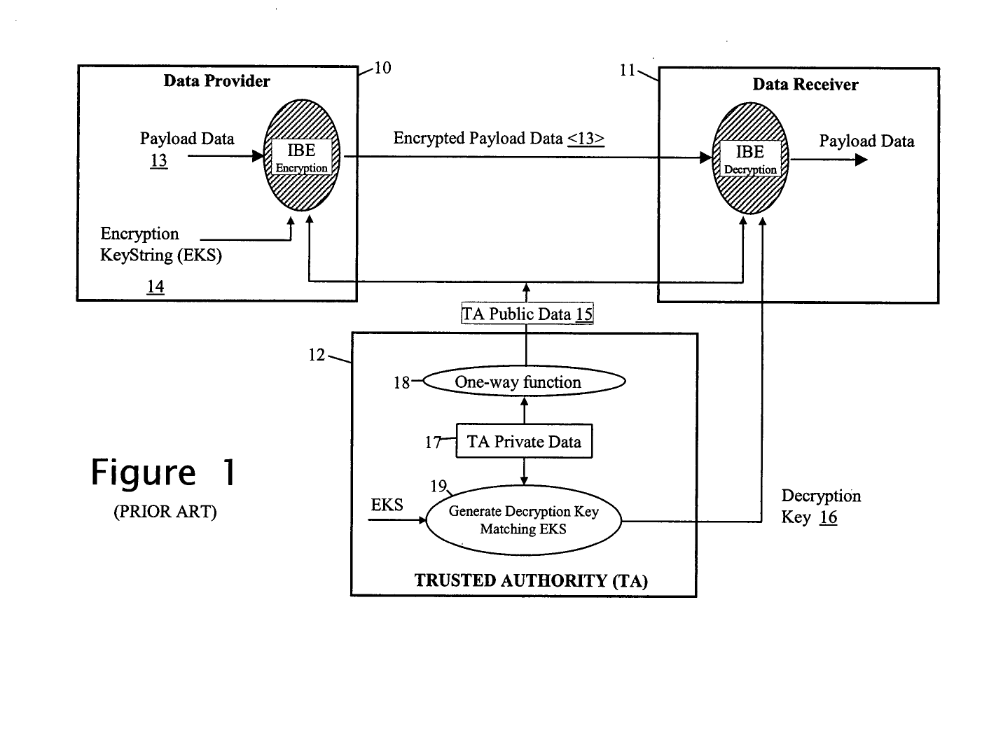

The FIG. 3 arrangement employs Identifier-Based Encryption with the entities 20, 30 and 40 having the roles of the data provider 10, data recipient 11 and trusted authority 12 of the FIG. 1 IBE arrangement. The IBE algorithm used is, for example, the QR algorithm described above with respect to FIG. 1.

As will be more fully described below, the encryption key string used to encrypt the image data 60 comprises a thumbnail (low resolution version) of the image represented by the image data, and a decryption-key release policy specifying at least one condition that the trusted service 40 must be satisfied has been met before providing the decryption key to the data-recipient device 30. Example policy conditions include that the receiving mobile device is associated with a particular person (as identified by an email address, telephone number, etc.), that a particular time has been reached, that a payment has been made, and that the trusted service has sent a notification to the data-provider device 20.

Considering the FIG. 3 arrangement in more detail, the data-provider device 20 comprises a communications interface 21, a user interface 22 (typically a keypad and display), a multimedia data store 23 holding the image data 60, and an IBE add-in module 24.

The module 24 is, for example, an extension SIM card (where the device 20 is a mobile phone), a PCMCIA card, USB token, a smartcard, etc. The module 24 comprises the following functional blocks:
a policy editor 25 for enabling a user to specify, via user interface 22, one or more conditions to constitute the decryption-key release policy. The policy editor operates, for example, by presenting the user with selection menus, simple fields to be filled in, and check boxes to be selected; the policy editor can also be arranged to access information stored on the device 20 such as address book information, profile information, previously-specified key release policies, etc. The policy can be expressed in any suitable language, for example XML.
a thumbnail generator 26 for generating thumbnail data representing a thumbnail of an image presented to it in the form of image data;
an IBE encryption unit 27 for encrypting data using the public data of the trusted service (the parameter N for the QR IBE method), and the encryption key string;
an IBE decryption unit 28 (which, of course, is not required for encrypting data);
a control unit 29 for coordinating the operation of the other elements of the module 24.

As an example usage, the user of the device 20 may wish to publish the image represented by the image data in such a manner that access to the full image is only provided to recipients who pay a specified amount. To this end, the user of device 20, arranges to send the encrypted image data to a list of potential customers including, in this case, the user of the device 30. The user of device 20 does this by selecting the image data 60 for sending to the target set of customers, and then initiating the encryption process. This cause the module 24 to be brought into action, enabling the user to use the policy editor 25 specify the required key-release policy—in this example, the payment of a specified amount into an identified account. In parallel with, or on completion of policy specification, the thumbnail generator 26 processes the image data 60 to generate corresponding thumbnail data. The thumbnail data and the policy data are then passed to the IBE encryption unit 27 where they are concatenated to form the encryption key string which the unit 27 then uses, together with the public data N of the trusted service 40 to encrypt the payload data here formed by the image data 60. The encrypted payload data 67 and the encryption key string 64 are then provided as a package 68 to the communications interface 21 for sending out over the communications infrastructure 51 according to a specified recipient list.

The package 68 is received by the mobile device 30 (see arrow 52). The device 30 is similar to the device 20 and comprises a communications interface 31, a user interface 32 (typically a keypad and display), and an IBE add-in module 34 similar to the module 24. For the purposes of accessing the received encrypted image data 67, the only element of the module 34 that is of relevance is the IBE decryption unit 38 (though, of course, the control unit 29 provides an overall control of the operation of the module 34).

Since the encryption key string 64 is included in clear in the package 68, the user of the device 30 can access the thumbnail data to view a low resolution version of the image represented by the encrypted image data 67; the user can also see the policy condition specifying the amount to be paid for access to the full image. It will be appreciated that the thumbnail image available to the user of device 30 is of little practical use for purposes other than image preview because of its low quality.

Assuming that the user of the device 30 wishes to access the full image, the user arranges for the specified amount to be paid into the identified account and requests the decryption key from the trusted service 40 (see arrow 53), this request including the encryption key string 64. Payment can be made in any manner but is conveniently done in the same message to the trusted service 40 as used to request the decryption key (it being assumed that the trusted service provides payment services).

The trusted service 40 comprises a web service front-end for interfacing with the communications infrastructure 51, an IBE trusted authority entity 42, and back-end service entities 46 (here shown as including a payment service). The IBE trusted authority entity 42 comprises an IBE policy checker for interpreting the policy data in the encryption key string and checking that the specified condition(s) have been satisfied, and a decryption key generator 44 for generating a decryption key from the encryption key string and the private data of the trusted service (for the QR IBE method, the values p and q mentioned above).

Upon the front-end 41 receiving the request from the device 30, the front-end 41 first processes any payment request by using the back-end payment service 46. Once this payment process has been completed, the front-end passes the decryption key request to the trusted authority entity 42. The IBE policy checker 43 then determines what policy conditions are present—in this case, there is only one condition, namely a payment condition, and the checker contacts the payment service 46 to verify that the required payment has been made. If this check fails, the entity 42 causes a failure message to be returned to the device 30. If the check shows that the specified policy condition(s) have been met, the key generation module is used to generate the required decryption key 69 which is then provided to the device 30 (see arrow 54).

It may be noted that although the trusted service 40 will typically receive the encryption key string from the device 30 requesting the decryption key, other mechanisms could be established for providing the encryption key string to the trusted service 40; for example, the device 20 could provide the encryption key string to the trusted service 40 directly. Furthermore, rather than generation of the decryption key being deferred until all the policy conditions have been confirmed as having been met, the trusted authority entity 42 can be arranged to start generation of the decryption key in parallel with, or even before, the policy checker carries out its checks, provided that provision of the decryption key to the device 30 is deferred until the policy checker 43 confirms that all specified conditions have been satisfied.

On receipt of the decryption key 69, the device 30 uses its decryption module 38 to decrypt the encrypted payload data 67 thereby to recover the image data 60.

In the foregoing scenario, rather than the package 68 being sent to individual recipients, it can be sent to a public website where the thumbnail image is displayed along with the associated policy conditions. Interested parties can then download the package 68 and obtain the decryption key 69 as described above.

It will be appreciated that instead of the QR IBE method, the above-described embodiment can be implemented using any other suitable IBE algorithm, such as those mentioned above that use of Weil or Tate pairings, or are RSA based.

It will be appreciated that many other variants are possible to the above described embodiments of the invention. For example, the encryption key string can be constituted by the image thumbnail without the inclusion of any policy conditions—this does not imply that any recipient of the package 68 will be able to obtain the decryption key 69 from the trusted service 40 since the latter may well have its own access restrictions (the user of the data-provider device 20 having decided to rely upon these restrictions to limit access to the image data 60).

The payload data can comprise data additional to the image data 60. This additional data could, for example, be image data of one or more further images and in this case the encryption key string can also include corresponding thumbnail data for these further images.

The functionality provided on the add-in module 24, 34 could be built into the entity 20, 30 concerned or provided (either in module form or built into) a proxy device such as a docking station or PC for the mobile device concerned. It may be noted that the add-in module with its policy editor can be implemented without the thumbnail generator (or with the possibility of by-passing it) for use in applications where the encryption key string is not required to include an image thumbnail.

As already indicated, the trusted authority functionality can be integrated with the data provider entity (or, indeed, with a proxy of the latter).

Whilst the data-provider entity and data-recipient entity in the above described embodiment take the form of mobile devices, it will be appreciated that one or both of these entities could take another form such as a traditional PC or an on-line service.

In another example scenario, rather than using a communications infrastructure to distribute images, a storage disc such as a CD-ROM or DVD can be used to distribute a large number of encrypted full images each with an associated encryption key string comprising corresponding thumbnail data and any related policy conditions. Such a disc could be distributed by anyone and the trusted service whose public data has been used in the encryption process could be a commercial trusted service set up for providing this role to anyone (the service would typically include a payment service as described above). When a possessor of the disc wishes to see a particular image in full, that party supplies the thumbnail to the trusted service and makes the required payment (or does whatever is required by the associated policy conditions); the trusted service then supplies back the decryption key (all of which can be done over a low bandwidth link).

Although in the foregoing, only a single trusted authority is involved, it is possible to require the involvement of multiple trusted authorities before an interested party is enabled to decrypt the encrypted payload data. This can be achieved in a number of ways, for example:
the data-provide entity 20 organises the image data 60 as a number of data strings (say n strings) by using Shamir's secret sharing scheme and then encrypts each string using the public data of a respective trusted authority and a respective encryption key string (typically specifying respective conditions to be checked); in order to decrypt the image, the receiving party 30 has to decrypt all of the strings—because any n−1 strings or less cannot disclose any information of the service. The Shamir secret sharing scheme also allows an implementation in which the participation of any t out of n share holders is sufficient to enable recovery of the secret.
the data-provider entity 20 can use the data encrypted in respect of one policy condition as the data to be encrypted in respect of the next condition, the encrypted data resulting from the encryption effected in respect of all said conditions then being sent to the requesting party for decryption in successive decryption operations.
the data-provider entity 20 can encrypt the image data 60 using public data from each of the trusted authorities, decryption of the encrypted item only being possible by obtaining a decryption sub-key from the corresponding trusted authority. Further information about how multiple trust authorities can be used is given in:
   Chen L., K. Harrison, A. Moss, N. P. Smart and D. Soldera. “Certification of public keys within an identity based system” Proceedings of Information Security Conference 2002, ed. A. H. Chan and V. Gligor, LNCS 2433, pages 322-333, Springer-Verlag, 2002.

1. A method for the secure provision of image data representing an image, the method comprising:
generating thumbnail data that represents a low-resolution version of the image represented by said image data;
encrypting payload data comprising said image data, this encryption being effected using encryption parameters comprising public data of a trusted party and an encryption key string comprising said thumbnail data; and
outputting the encrypted payload data and said encryption key string.

2. A method according to claim 1, wherein the encryption key string further comprises at least one condition to be satisfied before release of a decryption key for decrypting the payload data.

3. A method according to claim 2, further comprising constructing the encryption key string by a process involving user selection of the said at least one condition.

4. A method according to claim 1, further comprising:
receiving the encrypted payload data at a receiving party and requesting a decryption key from the trusted party;
at the trusted party, generating a decryption key for decrypting the payload data and providing the decryption key to said receiving party, the decryption key being generated using both private data of the trusted party that is related to said public data, and the encryption key string.

5. A method according to claim 4, wherein the encryption key string further comprises at least one condition, the trusted party checking that the at least one condition is satisfied in respect of the receiving party before providing the decryption key to the receiving party.

6. A method according to claim 5, wherein the trusted party only generates the decryption key after being satisfied that said at least one condition has been met.

7. A method according to claim 5, wherein the receiving party provides the encryption key string to the trusted party when requesting the decryption key.

8. A method according to claim 1, wherein the payload data comprises further data in addition to said image data.

9. A method according to claim 8, wherein said further data comprises further image data representing at least one further image, the encryption key string further comprising further thumbnail data that represents a low-resolution version of the or each image represented by said further image data.

10. A method according to claim 9, wherein encryption of the payload data is effected using the respective public data of multiple trusted parties such that decryption of the payload data requires the involvement of more than one trusted party.

11. A method for the secure provision of payload data that comprises image data representing an image, the method comprising encrypting the payload data using an Identifier-Based Encryption process employing an encryption key string comprising data that represents a low-resolution version of said image.

12. Apparatus for the secure provision of image data representing an image, the apparatus comprising:
a first arrangement arranged to provide payload data comprising said image data;
a second arrangement arranged to generate thumbnail data that represents a low-resolution version of the image represented by said image data;
a third arrangement arranged to encrypt the payload data using encryption parameters comprising public data of a trusted party and an encryption key string comprising said thumbnail data; and
a fourth arrangement arranged to output the encrypted payload data and said encryption key string.

13. Apparatus according to claim 12, wherein the third arrangement includes means for forming the encryption key string by combining said thumbnail data with at least one condition intended to be satisfied before release of a decryption key for decrypting the payload data.

14. Apparatus according to claim 13, wherein the means for forming the encryption key string comprises means for enabling user selection of the said at least one condition.

15. Apparatus according to claim 12, wherein the first arrangement is arranged to provide said payload data by combining the image data with further data.

16. Apparatus according to claim 12, wherein the first arrangement is arranged to provide said payload data by combining said image data with further image data representing at least one further image, the second arrangement being arranged to form further thumbnail data that represents a low-resolution version of the or each image represented by said further image data, and said encryption key string arranged to be used by the third arrangement further comprising the further thumbnail nail.

17. Apparatus according to claim 12, wherein the third arrangement is arranged to encrypt the payload data using the respective public data of multiple trusted parties such that decryption of the payload data requires the involvement of more than one trusted party.

18. A system comprising:
apparatus according to claim 12 for providing encrypted payload data;
a receiving entity for receiving the encrypted payload data and requesting a decryption key from the trusted party; and
a trusted-party entity, associated with said trusted party, for providing the receiving entity with a decryption key for decrypting the payload data, the trusted-party entity being arranged to generate the decryption key using both private data of the trusted party that is related to said public data, and the encryption key string.

19. A system according to claim 18, wherein the third arrangement includes means for forming the encryption key string by combining said thumbnail data with at least one condition, the trusted-party entity being arranged to provide the decryption key to the receiving entity only after being satisfied that said at least one condition has been met.

20. A system according to claim 19, wherein the trusted-party entity is arranged to generate the decryption key only after being satisfied that said at least one condition has been met.

21. A system according to claim 18, wherein the receiving entity is arranged to provide the encryption key string to the trusted-party entity when requesting the decryption key.

22. A physical add-in module for enabling apparatus to which the module has been added to securely provide payload data that comprises image data, the module comprising:
first means for generating thumbnail data that represents a low-resolution version of the image represented by said image data;
second means for forming an encryption key string comprising said thumbnail data; and at least one condition selected by a user of the apparatus via a user interface of the latter; and
third means for encrypting the payload data using encryption parameters comprising public data of a trusted party and said encryption key string.

23. A module according to claim 22, further comprising fourth means for decrypting encrypted data received at the apparatus by use of a decryption key provided by a trusted party associated with the received encrypted data.
